(19) United States
(12) Patent Application Publication
(10) Pub. No.: US 2007/0120087 A1
(43) Pub. Date: May 31, 2007

(54) Valve body with multiconical geometry at the valve seat

(75) Inventors: Nestor Rodriguez-Amaya, Stuttgart (DE); Heinz Stutzenberger, Vaihingen (DE); Andreas Dutt, Stuttgart (DE); Bernhard Henkel, Vaihingen/Enz (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: WMS Gaming Inc., Waukegan, IL (US)

(21) Appl. No.: 10/582,792

(22) PCT Filed: Oct. 22, 2004
(86) PCT No.: PCT/DE04/02356

§ 371 Date: Jun. 14, 2006

(30) Foreign Application Priority Data
Dec. 17, 2003 (DE) 103 59 302.0

(51) Int. Cl. F16K 1/38

(52) U.S. Cl. 251/356

(57) ABSTRACT

A valve for controlling fluids that are at high pressure has a valve seat region at which a high-pressure region and a low-pressure region can be made to communicate with one another or can be disconnected from one another. A seat face for a conical valve member is embodied on a valve body, and the seat face extends in inclined fashion in the valve body. The conical valve member has a multiconical geometry in the valve seat region, with at least one first conical face and one second conical face, which have different cone angles from one another.

### FIELD OF THE INVENTION

In fuel injection systems that can be used for instance in mixture-compressing or self-igniting internal combustion engines, magnet valves are now used for controlling the fuel quantity. In the closed state of the magnet valves, these valves assure that no fuel can flow out of an enclosed volume. In the open state, conversely, the fuel flow is enabled. With such valves, when used for instance in fuel injection systems for direct-injection engines, high system pressures, which are on the order of magnitude of more than 1500 bar, must be mastered. The valve seats embodied in these valves are manufactured with a single cone in an I-valve (inward-opening arrangement) or O-valve (outward-opening arrangement) version.

### PRIOR ART

Valves that are used in fuel injection systems for self-igniting internal combustion engines are becoming smaller and smaller for the sake of installation space, yet conversely the system pressures to be mastered have a sharply rising trend. In such valves, this leads to higher loads, especially in the valve seat region. Because of these higher loads, not only cavitation but also mechanical wear of the valve seat in the sealing region can occur. One such valve is known from German Patent DE 42 38 727 C2.

Wear that occurs at elevated loads in the valve seat region leads to a change in the switching behavior with regard to the opening and closing process over the life of such valves and thus leads to a drift in the injection quantity as the life of a valve with a single cone ages.

In the conventional valve seat of a magnet valve, of the kind used in high-pressure injection systems, for instance, the valve needle and the valve body in which the valve needle is guided are made with different cone angles. Because of this, there is a seat angle difference in the valve seat region. On the one hand, the seat angle difference makes for a precisely defined sealing edge when the valve is new. In valve seats with single cones, the seat angle difference also causes a damping gap to develop between the valve needle and the valve body.

Because of the mechanical wear in the sealing region that occurs over the life of the magnet valve, the cone angles of the valve needle and the valve body become similar with increasing time in operation. From a linear seal (sealing edge) when the magnet valve is new, over the course of time in operation a flattened seal is created once the valve has been run in. Depending on the configuration of the surface structure of the sealing face that is established because of wear, high pressure P_{HP} can get under this sealing face. Because of the transition from linear sealing in the new state to a flattened seal in the run-in state, the hydraulically effective sealing diameter d_{hydr.}. shifts from the original sealing edge into the wear region. This means that the original hydraulically effective sealing diameter d_{hydr.}. decreases. The hydraulically effective sealing diameter d_{hydr.operation,DL} established in the run-in state with a flattened seal is less than the hydraulically effective sealing diameter d_{hydr.}. in the new state, and as a result the hydraulically effective surface area changes. Because of a change in the hydraulically effective surface area in the valve seat region of the magnet valve, the force ratios engaging the valve needle change, which causes an unwanted change in the switching behavior of the magnet valve over its life and thus causes a quantity drift.

### SUMMARY OF THE INVENTION

If the least possible quantity drift in the fuel quantity to be injected into the combustion chamber of an internal combustion engine over the service life is to be attained, the hydraulically effective sealing diameter d_{hydr.}. must remain as constant as possible over the life of a valve. To achieve this, the valve seat, proposed according to the invention, of a magnet valve for use in high-pressure fuel injection systems has for example a double-cone or multiconical geometry, including undercuts. The design of a valve seat proposed according to the invention is distinguished by the fact that in the sealing region of the valve seat, the seat angle difference is reduced, and downstream of the sealing region (the free region) of the valve seat, the seat angle difference is increased. The double-cone or multiconical geometry, when the valve is new, leads to a flattened seal, that is, a flattened contact region, since the slight seat angle difference and roughness or tolerances in smoothness of the valve needle and the valve body assure that not only will the outer edge of the valve needle rest on the valve body, but so will “roughness points”, which originate in the machining, between the valve needle and the valve body. When the valve is new, accordingly, unlike the variant embodiments with a single cone known from the prior art, there is no linear sealing region (or sealing edge). Because of an increased seat angle difference in the free region, that is, downstream of the sealing region, a limitation of the ensuing mechanical wear can be achieved. By this provision, the hydraulically effective sealing diameter d_{hydr.}. in the new state is reduced, and in the run-in state of the valve it is stabilized. Thus the hydraulically effective sealing diameter d_{hydr.}. can be kept virtually constant over the life of the valve proposed according to the invention. As a result, a quantity drift in the fuel quantity injected into the combustion chamber of an internal combustion engine, and its variation over the life of the valve, can be reduced. Because of the essentially constant hydraulically effective sealing diameter d_{hydr.}., a change in the switching behavior of the valve, equipped with the seat geometry proposed according to the invention, can accordingly advantageously be maximally avoided.

The embodiment proposed according to the invention of a valve seat as a double-cone or multiconical geometry can advantageously be employed especially in high-pressure injection systems, of the kind used in self-igniting internal combustion engines, in which pressures of more than 1500 bar must remain capable of being mastered. The design proposed according to the invention of the valve seat can be employed in both inward-opening valves (I-valves) and outward-opening valves (O-valves). In an advantageous variant embodiment, because of conical faces extending on both sides of a sealing edge, if the sealing edge becomes worn the hydraulically effective sealing diameter d_{hydr.}. is unchanged, since the seat adaptation that occurs in operation because of the flattening of the sealing edge simultaneously extends both radially inward and radially outward. As a result, from an originally linear sealing, over the course of the life of the valve, with increasing flattening of the sealing edge, a sealing face that becomes larger symmetrically on both sides is created, whose characteristic is a constant, hydraulically effective sealing diameter d_{hydr.}.

### DRAWING

The invention is described in further detail below in conjunction with the drawing.

Shown are:

FIG. 1, a variant embodiment of a double-cone seat geometry in an I-valve;

FIG. 2, a further variant embodiment of a double-cone seat geometry in an I-valve in the valve seat region;

FIG. 3, a further variant embodiment of a valve seat region in an I-valve, with conical faces extending on both sides of the sealing edge;

FIG. 4, a further variant embodiment of a sealing edge in a valve seat region of an I-valve, again with conical faces on both sides of the sealing edge;

FIG. 5, a variant embodiment of a multiconical geometry in the valve seat region, with a pocket let into the valve body;

FIG. 6, a first variant embodiment of a multiconical geometry in the valve seat region of an O-valve;

FIG. 7, a further variant embodiment of a valve seat region in an O-valve;

FIG. 8, a further variant embodiment of a valve seat region in an O-valve with a chamfered valve body sealing face;

FIG. 9, a further variant embodiment of a valve seat region designed according to the invention, with a sealing edge toward which two frustoconical faces extend; and

FIG. 10, a further variant embodiment of a valve seat region in an O-valve, with a pocket integrated into the valve body sealing face.

### VARIANT EMBODIMENTS

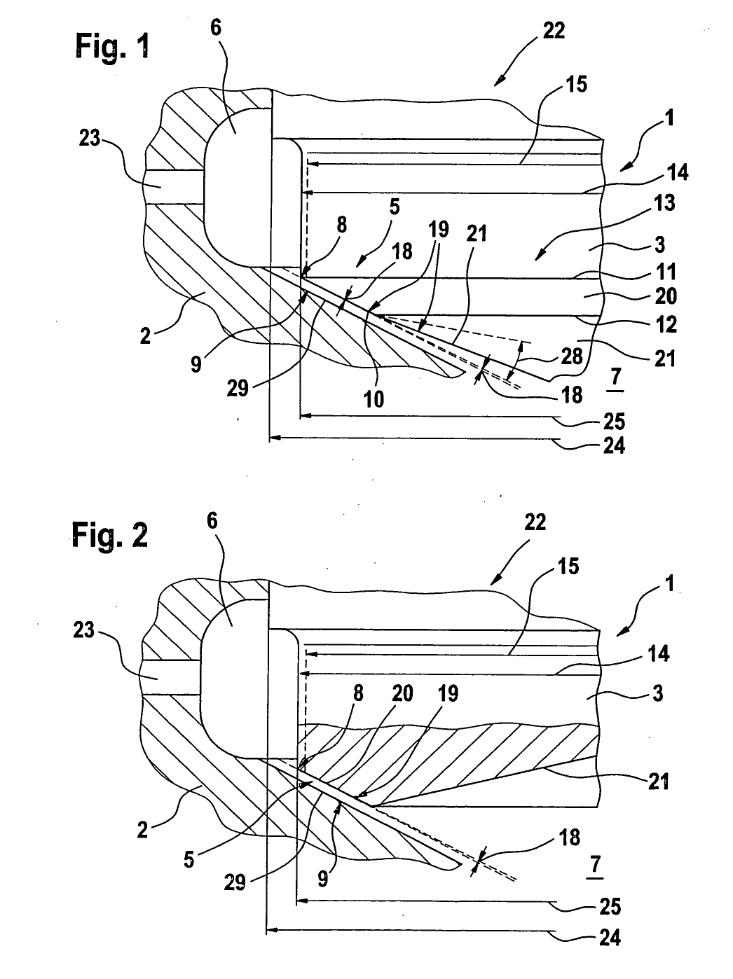

FIG. 1 shows a variant embodiment of the multiconical geometry, proposed according to the invention, at a valve seat region of an I-valve.

A magnet valve 1, such as a diesel magnet valve used in high-pressure fuel injection systems, includes a valve body 2 and a valve member 3 guided in it and embodied as a valve needle 3. The valve member 3 and the valve body 2 are constructed symmetrically to a line of symmetry. A valve seat region between the valve body 2 and the valve needle 3 is identified by reference numeral 5. By means of the valve seat region 5, in the closed state of the valve needle 3, a high-pressure region 6, in which a high pressure PHP prevails, and a low-pressure region 7, in which a lesser pressure P_{LP} prevails, are separated from one another.

In the variant embodiment of the valve seat region 5 shown in FIG. 1, a sealing edge 8 is defined by the sealing edge diameter 25 (d_{S}) of a first conical face 20 of a multiple cone 19. Inside the first conical face 20, a seat angle difference 18 is embodied. The seat angle difference 18 amounts to only a few degrees (≦5°). When the valve 1 is new, the sealing edge diameter 25 d_{S} approximately coincides with the hydraulically effective sealing diameter 14 d_{hydr,new}. Because of the seat angle difference 18 embodied at the first conical face 20, the contact between the sealing edge 8 and the seat face 29, over the course of operation, changes over into a flattish contact, but because of the slight seat angle difference 18, it is assured that a hydraulically effective sealing diameter 15 d_{hydr. operation} (dashed line in FIG. 1), which is established over the course of the time in operation, essentially matches the hydraulically effective sealing diameter 14 d_{hydr.,new} of the valve when new. The second conical face 21, adjoining the first conical face 20, of the multiconical geometry 19 can be provided with a conical face whose angle is within an annular region 28 (see the illustration in FIG. 1). Because of the provision of the second conical face 21, which does not come into contact with the seat face 29 of the valve body 2, it is assured that the sealing action occurs only between the first conical face 20, embodied with the seat angle difference 18, and the seat face 29 of the valve body 2. As a result, the inlet width and closure width are limited.

The angle of inclination, with which a second conical face 21 of the multiconical geometry 19 is embodied, can be within the range represented by the angle of inclination 28. The second conical face 21 of the multiconical geometry 19, below the second encompassing edge 12 on the valve needle 3, adjoins the first conical face 20 of the multiconical geometry 19. In cooperation with the seat face 29 of the valve body 2, in the closed state of the valve needle 3, both when the valve is new and in the state in which the valve needle 3 is fully run in, a flattish sealing of the high-pressure region 6, where high pressure P_{HP} off from the low-pressure region 7, in which low pressure P_{LP} prevails, is achieved. In the view shown in FIG. 1, the outside diameter of the valve needle 3 is represented by reference numeral 24 (d_{N}).

The spacing shown in FIG. 1 between the first conical face 20 of the valve needle 3 and the seat face 29 of the valve body 2 functions, given a suitable selection of the cone angle 28 of the second conical face 21, as a damping angle, since upon closure of the valve needle 3, the fuel located in the gap must be expelled, so that the impact of the first conical face 20 on the seat face 29 is damped by the fuel still contained in a damping gap 10.

FIG. 2 shows a further variant embodiment of a valve seat region, proposed according to the invention, in an I-valve.

The high-pressure region 6, which is supplied via the high-pressure inlet 23, is separated from the low-pressure region 7, in which low pressure P_{LP} prevails, by the first conical face 20 of the valve needle 3.

In a distinction from the variant embodiment shown in FIG. 1, in the variant embodiment shown in FIG. 2 of an I-valve 22 proposed according to the invention, the second conical face 21 is folded over inward; that is, in comparison to the variant embodiment shown in FIG. 1, the second conical face 21 makes no contribution to the damping.

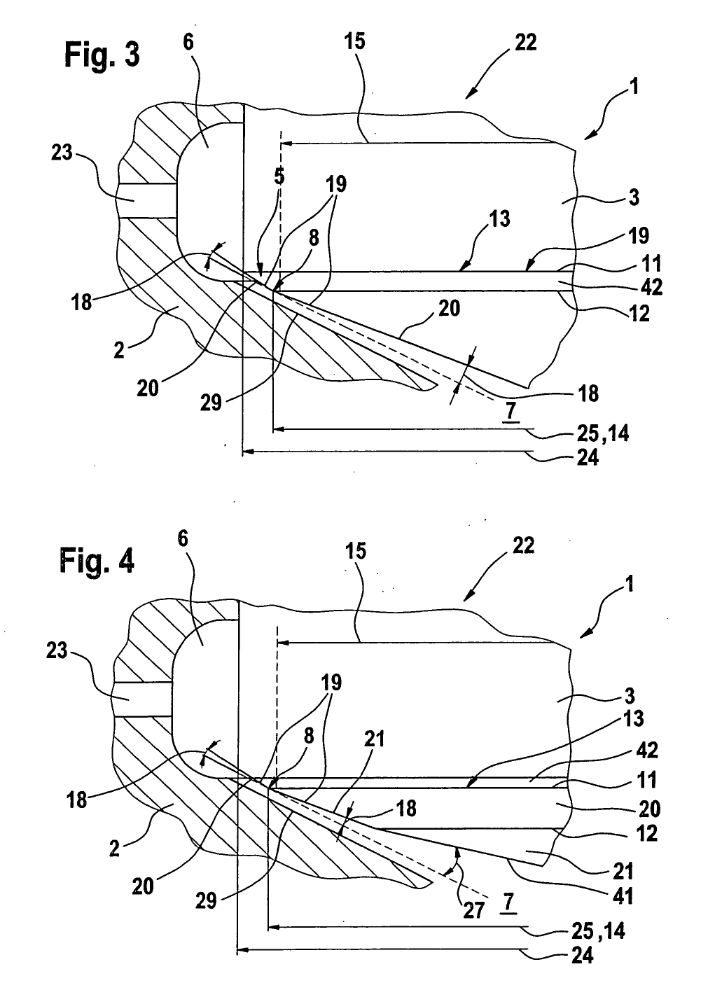

FIG. 3 shows a multiconical geometry at the valve needle of an I-valve.

It can be seen from the illustration in FIG. 3 that the sealing edge 8, when the valve 1 is new, is embodied with the sealing edge diameter 25 (d_{S}). The sealing edge diameter 25 (d_{S}), when the valve 1 is new, corresponds to the hydraulically effective sealing diameter d_{hydr.new} (see reference numeral 14). The conical faces 20 and 21 of the multiconical geometry 19 extend on both sides of the sealing edge 8 in the valve seat region 5. The first conical face 21 of the multiconical geometry 19 is embodied with the seat angle difference 18, while the second conical face 21, which adjoins the first conical face 20 below the second encompassing edge 12, has a further seat angle difference 27, relative to the seat face 29 and the second conical face 21. Given a flattening that ensues in the course of operation in the region of the sealing edge 8 upon contact with the seat face 29, diametrically opposite, of the valve body 2, a seat adaptation occurs simultaneously both radially inward and radially outward, so that as the running in increases and with the ensuing wear, the hydraulically effective sealing diameter d_{hydr.operation} remains essentially unchanged. In the view shown in FIG. 3, the sealing edge 8 coincides with the second encompassing edge 12 of the valve needle 3.

FIG. 4 shows a variant embodiment of the valve seat proposed according to the invention of FIG. 3.

Unlike the variant embodiment shown in FIG. 3, in the variant embodiment of FIG. 4, a further, third conical face 41 is embodied below the second conical face 21. The further, third conical face 41 defines the possible inlet or wear region of the first conical face 20, so that the wear can propagate only at most to the second encompassing edge 12. The mode of operation of the valve seat shown in FIG. 4 is analogous to the mode of operation of the valve seat shown in FIG. 3.

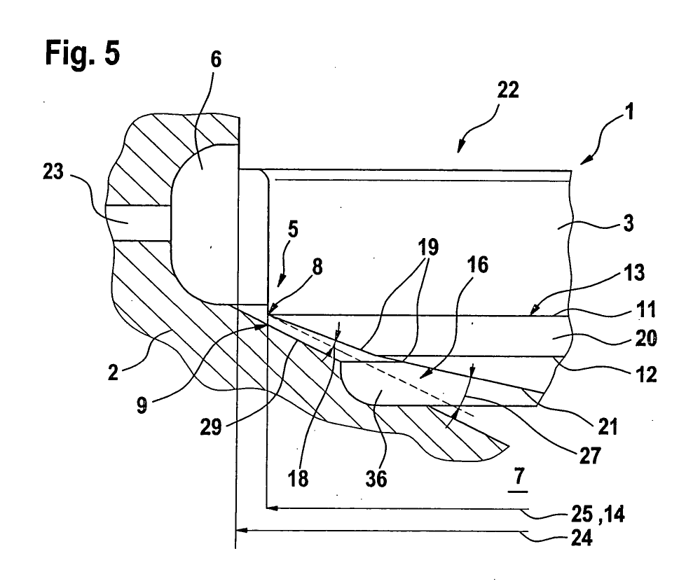

FIG. 5 shows a further variant embodiment of a valve seat region designed according to the invention.

Unlike the variant embodiments shown in FIGS. 1 through 4, in the variant embodiment shown in FIG. 5, a pocket 36 (or relief groove) is embodied in the seat face 29 of the valve body 2. The pocket 36 is located facing the second encompassing edge 12 that separates the first conical face 20 from the second conical face 21 of the multiconical geometry 19. The task of the pocket 36 embodied in the seat face 29 is to limit the wear, which occurs upon contact of the first conical face 20 with the seat face 29, to the conical face 20.

The first conical face 20 is embodied with the seat angle difference 18, while the second conical face 21, below the second encompassing edge 12, on the valve needle 3 has a cone angle 27, which is greater than the seat angle difference 18 of the first conical face 20. In this case again, the sealing edge diameter 25 (d_{S}) coincides with the outer diameter of the first conical face 20 of the multiconical geometry 19. The needle diameter 24 (d_{N}) of the valve needle 3 simultaneously corresponds to the reference diameter of the valve body 2. With the variant embodiment shown in FIG. 5 of an I-valve 22 as well, a virtually constant hydraulically effective sealing diameter when the valve is new can be achieved, compared to the state in which the valve seat has been run in.

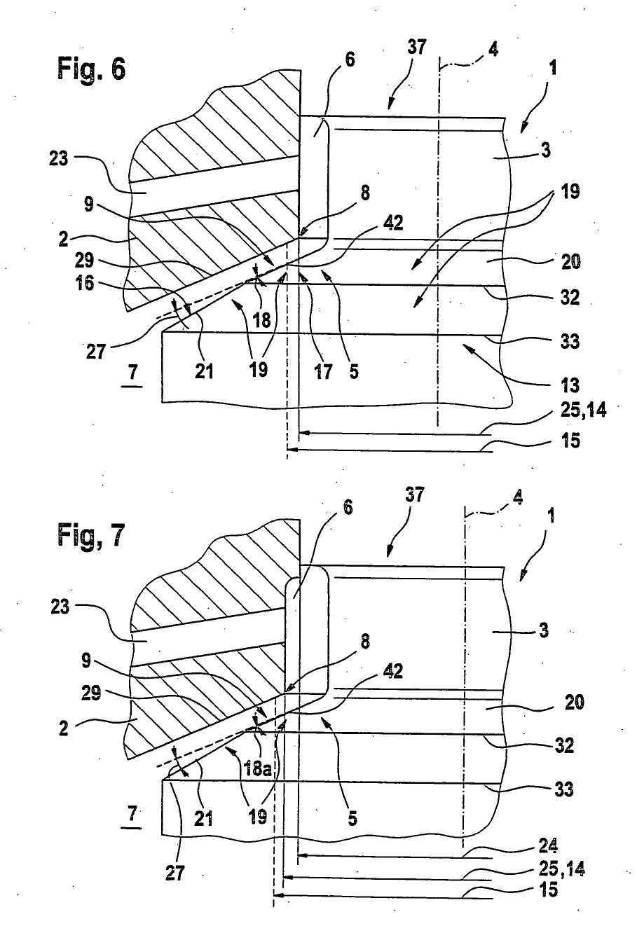

While in the variant embodiments of the invention in FIGS. 1 through 5, I-valve seats 22 have been described, that is, valves that open inward, in the variant embodiments sketched below, O-valves will be described. In the I-valves identified by reference numeral 22, the valve needle 3 opens in the direction of the high-pressure inlet 23 and enables a fluidic communication between the high-pressure region 6 and the low-pressure region 7. By comparison, the variant embodiments described below in conjunction with FIGS. 6 through 10 involve O-valves, in which the valve needle 3 opens away, or in other words outward, relative to the high-pressure inlet 23 into the high-pressure region 6.

FIG. 6 shows a first variant embodiment of a valve seat region for an O-valve, with an outward-opening valve body.

The magnet valve 1 shown in FIG. 6 includes the valve body 2, on which the seat face 29 is embodied. Via a high-pressure inlet 23 that penetrates the valve body 2 of the magnet valve 1, fuel at high pressure flows to the high-pressure region 6, in which high pressure P_{HP} prevails. The valve needle 3 of the magnet valve 1 is constructed symmetrically to the line of symmetry 4. A first encompassing edge of the outward-opening valve needle 3 is identified by reference numeral 32, while a further, second encompassing edge of the outward-opening valve needle 3 is identified by reference numeral 33. In the valve seat region 5, diametrically opposite the seat face 29 of the valve body 2, the multiconical geometry 19 is embodied, which includes both a first conical face 20 and a second conical face 21. The first conical face 20 of the multiconical geometry 19 is embodied with the seat angle difference 18, while the second conical face 21, which adjoins the first conical face 20 along the first encompassing edge 32 of the valve needle 3, is embodied with a cone angle 27 that is greater than the seat angle difference 18. In the open state, shown in FIG. 6, of the outward-opening valve needle 3, the high-pressure region 6 and the low-pressure region 7, in which low pressure P_{LP} prevails, communicate with one another. The sealing edge diameter 25 d_{S} is largely equivalent to the hydraulically effective sealing diameter d_{hydr.,new} 14 in the new state of the valve 1. While the first conical face 20 of the multiconical geometry 19 is embodied with a seat angle difference 18, the second conical face 21 extends with a further seat angle difference 27, which is selected to be greater than the seat angle difference 18 of the first conical face 20. As a result, the wearing region at the valve needle 3 is limited to the region between the sealing edge 8 and the first encompassing edge 32 of the outward-opening valve needle 3. This region (see reference numeral 9) identifies the inlet/closure region between the seat face 29 on the valve body 2 and the first conical face 20 of the multiconical geometry 19.

In the O-valve 37 shown in FIG. 6, the sealing edge 8 is embodied at the edge of the seat face 29, diametrically opposite the first conical face 20.

FIG. 7 shows a further variant embodiment of an O-valve, having a valve needle on which a multiconical geometry is embodied.

Unlike the variant embodiment shown in FIG. 6 of the design proposed according to the invention of the valve seat region 5, a recess configured in pocketlike fashion is located on the valve body 2. Inside the recess of the valve body 2, into which the high-pressure inlet 23 discharges, the sealing edge 8 is embodied at the seat face 29. In the variant embodiment shown in FIG. 7 as well of the valve seat region 5, proposed according to the invention, on the magnet valve 1, the sealing edge 8 is located facing the first conical face 20. The first conical face 20 of the multiconical geometry 19 extends with the seat angle difference 18 relative to the seat face 29 of the valve body 2. The first encompassing edge 32 of the outward-opening valve needle 3 of the magnet valve 1 is adjoined by the second conical face 21 of the multiconical geometry 19, which in comparison to the first conical face 20 is embodied with the cone angle (27). The first conical face 20 forms a sealing face 17, while conversely the second conical face 21 of the multiconical geometry 19, because of the larger cone angle 27, represents a free face for limiting wear.

Because of the embodiment of a pocket in the high-pressure region 6 between the valve body 2 and the valve needle 3, the diameter d_{N} 24 of the valve needle 3 and the seat diameter d_{S} 25 do not coincide in the variant embodiment of FIG. 7; instead, the seat diameter d_{S} 25 exceeds the needle diameter d_{N} 24 of the valve needle 3. By comparison to the variant embodiment of the O-valve 37 shown in FIG. 6, in the variant embodiment in FIG. 7 the sealing edge 8 is shifted outward by the amount of the pocket depth in the valve body 2, so that in comparison to the variant embodiment of FIG. 6, a greater seat diameter d_{S} 25 ensues.

In the new state of the valve 1, the hydraulically effective sealing diameter d_{hydr.,new} of the valve coincides approximately with the sealing edge diameter 25 (d_{S}). Over the course of operation of the valve, the hydraulically effective sealing diameter 25 d_{hydr.operation} conversely shifts only insignificantly, as indicated by dashed lines in FIG. 7.

In the variant embodiment shown in FIG. 7 of an O-valve 37, the sealing edge 8 is located facing approximately the middle of the first conical face 20 of the multiconical geometry 19, which has the seat angle difference 18. The first conical face 20 of the multiconical geometry 19 functions as a sealing face, while the second conical face 21 with the seat angle difference 27, relative to the seat face 29 of the valve body 2, serves as a free face.

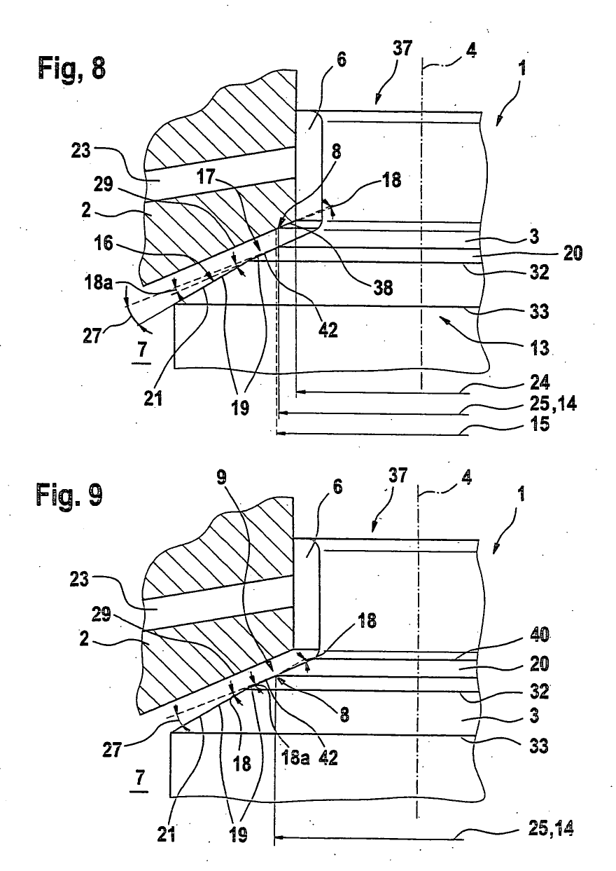

FIG. 8 shows a variant embodiment of the valve seat region, proposed according to the invention, with an oblique face embodied on the seat face of the valve body.

Unlike the variant embodiments of FIGS. 6 and 7, referring to an O-valve 27 and in which the seat face 29 extends continuously, in the variant embodiment shown in FIG. 8 a chamfer 38 on the seat face 29 is provided, which is inclined by an angle to the seat face 29. The transition from the seat face 29 to the chamfer 38 forms the sealing edge on the valve body 2. Analogously to the multiconical geometries on the valve needle 3 shown in FIGS. 6 and 7, the valve needle 3 shown in FIG. 8 is embodied with the first conical face 20 and the second conical face 21, which have cone angles 18 and 27, respectively, that differ from one another; that is, the seat angle difference 18 and the angle difference 27 of the first conical face 21. The sealing edge diameter 25 (d_{S}) is identical to the hydraulically effective sealing diameter d_{hydr.,new} in the new state. Over the course of operation, the inlet/closure region propagates both radially inward and radially outward, so that the hydraulically effective sealing diameter d_{hydr.operation} remains constant.

The first conical face 20 and the second conical face 21 are separated from one another by the first encompassing edge 32 of the outward-opening valve needle 3. The second encompassing edge 33 of the outward-opening valve needle 3 forms the boundary of the second conical face 21 on the valve needle 3. The transition point where the seat face 29 of the valve body 2 merges with the chamfer 38 forms the sealing edge 8.

In the position shown in FIG. 8 of the valve needle 3 in the valve body 2, the high-pressure inlet 23, which discharges into the high-pressure region 6, and the low-pressure region 7, in which low pressure P_{LP} prevails, communicate with one another, so that via the high-pressure inlet 23, fuel flows via the high-pressure region 6 into the low-pressure region 7 of the magnet valve 1.

FIG. 9 shows a further variant embodiment of an outward-opening valve needle.

The sealing edge 8 of the valve needle 3 is located in the first conical face 20 of the multiconical geometry 19 and is embodied with the seat angle differences 18 and 18a. Extending radially inward and radially outward, respectively, on either side of the sealing edge 8 relative to the valve needle 3, the first conical face 20 has seat angle differences 18 and 18a. If in operation of the outward-opening valve needle 3 of the O-valve 37 the sealing edge 8 strikes the seat face 29 of the valve body 2, then because of the seat angle differences 18 and 18a on both sides, the flattening of the sealing edge 8 extends symmetrically along the first conical face 20, or in other words symmetrically radially outward as well as symmetrically radially inward. As a result, in operation of the magnet valve 1, a uniformly extending flattening at the sealing edge 8 is achieved. The limitation of the inlet/closure region 9, in the variant embodiment shown in FIG. 9 of the valve seat region 5 proposed according to the invention, is effected as a result of the fact that the second conical face 21 of the multiconical geometry 19 has a more-acute cone angle than the first conical face 20.

In the new state of the valve 1, in the variant embodiment of FIG. 9, the diameter 25 of the sealing edge 8 at the valve needle 3 and the hydraulically effective sealing diameter d_{hydr.,new} 14 coincide. Over the course of operation, a hydraulically effective sealing diameter d_{hydr.operation} 15 ensues, which differs only insignificantly from the hydraulically effective sealing diameter 14 in the new state of the valve 1.

The boundary of the second conical face 21, acting as a free face, of the multiconical geometry 19 of the valve needle 3 is formed by the second encompassing edge 32 of the outward-opening valve needle 3. In the position of the valve needle 3 of FIG. 9, the high-pressure inlet 23 of the valve body 2, the high-pressure region 6 in which high pressure PHP prevails, and the low-pressure region 7 in which low pressure P_{LP} prevails, communicate fluidically with one another.

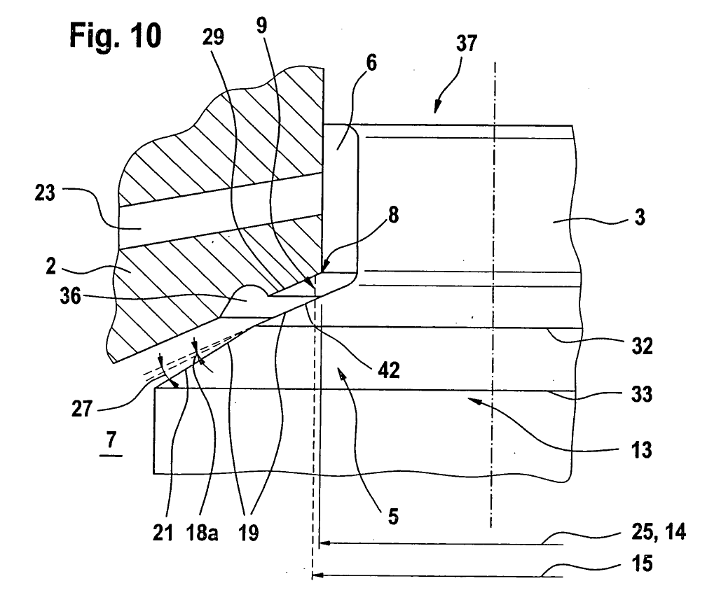

FIG. 10 finally shows a variant embodiment of an O-valve with a pocket embodied in the seat face of the valve body.

In the variant embodiment of the valve seat region 5 according to the invention shown in FIG. 10, the seat face 29 of the valve body 2 has a recess 36 configured in pocketlike fashion.

The pocket 36, which is embodied in the seat face 29 of the valve body 2, has the function of limiting the inlet/closure region 9 to the region between the sealing edge 8 at the valve body 2 and the first conical face 20 of the multiconical geometry 19. The same function at the valve needle 3 is performed by the second conical face 21 of the multiconical geometry 19, since the cone angle of the second conical face 21 has a more-acute course than that of the first conical face 20.

The valve needle 3 of the outward-opening valve 37 has the multiconical geometry 19, which includes both the first conical face 20 and the second conical face 21.

The second conical face 21 of the multiconical geometry 19 of the outward-opening valve needle 3 is embodied with the further seat angle difference 27. The first conical face 20 is defined by the first encompassing edge 32, at which the first conical face 20 merges with the second conical face 21, the latter being defined by the second encompassing edge 33. In the variant embodiment shown in FIG. 10 of an outward-opening valve 37, the inlet/closure region 9 is limited to the part of the seat face 29 located between the sealing edge 8 and the pocketlike recess 36, and to the first conical face 20.

In the new state of the outward-opening valve 37 shown in FIG. 10, the hydraulically effective sealing diameter d_{hydr.,new} (see reference numeral 14) coincides with the diameter of the sealing edge 8 in the valve body 2. The hydraulically effective sealing diameter d_{hydr.operation} (see reference numeral 15) that ensues after sometime in operation differs only insignificantly from the hydraulically effective sealing diameter 14 d_{hydr.,new} of the outward-opening valve 37, so that even after relatively long operation of the outward-opening valve 37, no impermissible forces that adversely affect the closing and opening behavior of the outward-opening valve 37 can be caused by the change in hydraulic surface areas. As a result, the replicability both of injection quantities and of the instants of opening and closing is assured.

### List of Reference Numerals

1 Magnet valve
2 Valve body
3 Valve needle
4 Line of symmetry
5 Valve seat region
6 High-pressure region (PHP)
7 Low-pressure region (PLP)
8 Sealing edge
9 Inlet/closure region
10 Damping gap
11 First encompassing edge
12 Second encompassing edge
13 Conical face of valve needle
14 Hydraulically effective sealing diameter d_{hydr,new}
15 Hydraulically effective sealing diameter d_{hydr,operation}
18 Seat angle difference (from sealing edge inward) 18a Seat angle difference (from sealing edge outward)
19 Multiconical geometry
20 First conical face
21 Second conical face
22 I-valve seat
23 High-pressure inlet
24 Diameter of valve needle (d_{N})
25 Sealing edge diameter (d_{S})
27 Further seat angle difference between seat face 29 and second conical face 21
28 Angular region
29 Seat face of valve body 2
32 First encompassing edge of valve needle
33 Second encompassing edge of valve needle
36 Relief groove
37 O-valve seat
38 Chamfer
40 Third encompassing edge, valve needle
41 Third conical face
42 Further conical face

1-10. (canceled)

11. In a valve for controlling fluids that are at high pressure, having a valve seat region, at which a high-pressure region and a low-pressure region can be made to communicate with one another or can be disconnected from one another, and having a valve body, at which a seat face is embodied for a conical valve member, the seat face extending in inclined fashion in the valve body, the improvement wherein the conical valve member comprises a multiconical geometry in the valve seat region, including at least one first conical face and one second conical face, and wherein the first conical face has a seat angle difference from the seat face of the valve body.

12. The valve in accordance with claim 11, wherein the second conical face of the multiconical geometry has a further seat angle difference that exceeds the seat angle difference of the first conical face.

13. The valve in accordance with claim 11, wherein the valve needle is the valve member of an inward-opening valve of an outward-opening valve.

14. The valve in accordance with claim 12, wherein the sealing edge coincides with an encompassing edge of the valve needle, and wherein conical face portions extend radially inward and radially outward from the sealing edge and have different seat angle differences from the seat face in the valve body.

15. The valve in accordance with claim 11, wherein the valve needle is the valve member of an inward-opening valve of an outward-opening valve, and wherein the seat angle difference between the first conical face and the seat face of the valve body is less than 5°.

16. The valve in accordance with claim 11, further comprising a pocketlike recess is embodied in the seat face of the valve body of the inward-opening valve, or in the seat face of the outward-opening valve.

17. The valve in accordance with claim 11, wherein the sealing edge coincides with one of the encompassing edges of the multiconical geometry and is located between the first conical face and the second conical face.

18. The valve in accordance with claim 17, wherein the seat angle difference at the first conical face is embodied as extending radially outward.

19. The valve in accordance with claim 11, wherein the sealing edge is embodied as an edge of a seat face of the valve body.

20. The valve in accordance with claim 11, wherein the sealing edge is located between the seat face and a chamfer embodied on the valve body, and wherein the chamfer has the seat angle difference from the seat face.
